(19) United States
(12) Patent Application Publication
(10) Pub. No.: US 2025/0153661 A1
(43) Pub. Date: May 15, 2025

(54) WIRE HARNESS ROUTING STRUCTURE

(71) Applicant: YAZAKI CORPORATION, Tokyo (JP)

(72) Inventors: Kenichi Imou, Makinohara-shi (JP); Taku Furuta, Makinohara-shi (JP); Mitsuhisa Sano, Makinohara-shi (JP); Ryo Hamada, Makinohara-shi (JP)

(21) Appl. No.: 18/935,398

(22) Filed: Nov. 1, 2024

(30) Foreign Application Priority Data
Nov. 14, 2023 (JP) 2023-194009

(51) Int. Cl. B60R 16/02

(52) U.S. Cl. CPC B60R 16/0215

(57) ABSTRACT

An object is to provide a wire harness routing structure capable of improving assemblability to a vehicle.

A wire harness routing structure includes a flat routing member having flexibility and extending along a vehicle width direction, and a pair of elastic members extending along the flat routing member and holding the flat routing member, and the flat routing member is fixed to a dash panel that partitions an engine room and a vehicle interior of a vehicle in a state of being sandwiched between the pair of elastic members.

### CROSS-REFERENCE TO RELATED APPLICATION(S)

The present application claims priority to and incorporates by reference the entire contents of Japanese Patent Application No. 2023-194009 filed in Japan on Nov. 14, 2023.

### BACKGROUND OF THE INVENTION

### 1. Field of the Invention

The present invention relates to a wire harness routing structure.

### 2. Description of the Related Art

As a technique related to a conventional wire harness routing structure, for example, Japanese Patent Application Laid-open No. 2012-055105 A discloses a wire harness routing structure including a flexible flat routing member, a protector for protecting the flat routing member, and a fixing member for fixing the protector to an attachment portion of a vehicle.

Meanwhile, with the wire harness routing structure described in Japanese Patent Application Laid-open No. 2012-055105 A described above, for example, there is room for further improvement in terms of improvement in assemblability to a vehicle.

### SUMMARY OF THE INVENTION

The present invention has been made in view of the above circumstances, and an object is to provide a wire harness routing structure capable of improving assemblability to a vehicle.

In order to achieve the above mentioned object, a wire harness routing structure according to one aspect of the present invention includes a flat routing member that has flexibility; and a pair of elastic members that extends along the flat routing member and holds the flat routing member, wherein the flat routing member is fixed to a dash panel that partitions an engine room and a vehicle interior of a vehicle in a state of being sandwiched between the pair of elastic members.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a vehicle to which a wire harness routing structure according to an embodiment is applied;

FIG. 2 is an exemplary cross-sectional view of a vehicle to which the wire harness routing structure according to the embodiment is applied;

FIG. 3 is an exemplary cross-sectional view of the wire harness routing structure according to the embodiment;

FIG. 4 is an exemplary cross-sectional view of the wire harness routing structure according to the embodiment, and is a view of a state in which a flat routing member and a pair of elastic members are removed from a dash panel;

FIG. 5 is an exemplary perspective view of the wire harness routing structure according to the embodiment; and

FIG. 6 is an exemplary perspective view of the wire harness routing structure according to the embodiment, and is a view of a state in which a part of a second sound absorbing material of the pair of elastic members is cut out.

### DETAILED DESCRIPTION OF THE PREFERRED EMBODIMENTS

Hereinafter, an embodiment according to the present invention will be described in detail with reference to the drawings. Note that this invention is not limited to the embodiment described below. In addition, the constituent elements in the embodiment described below include those that can be easily replaced by those skilled in the art or those that are substantially the same. Note that, in the present specification, ordinal numbers are used only to distinguish components, members, parts, positions, directions, and the like, and do not indicate order or priority.

### Embodiment

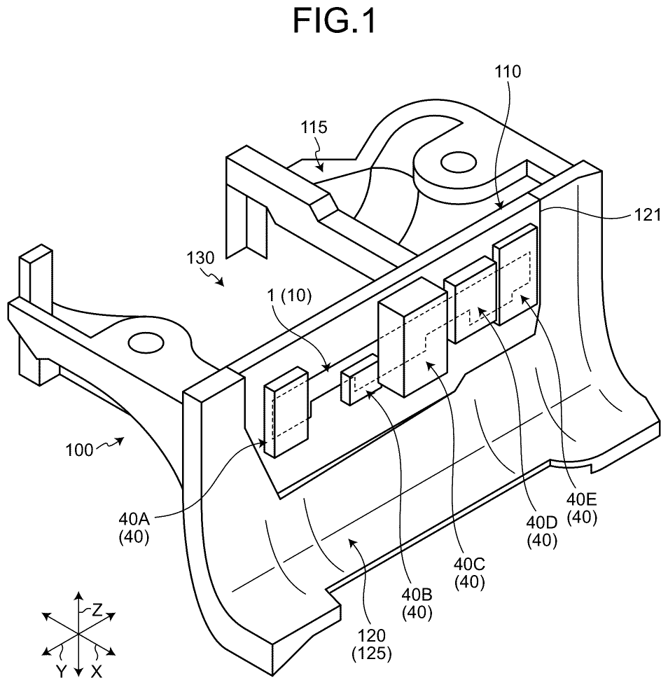

FIG. 1 is a perspective view of a vehicle 100 to which a wire harness routing structure 1 according to an embodiment is applied. The wire harness routing structure 1 of the present embodiment illustrated in FIG. 1 is applied to the vehicle 100, and is used for power supply and signal communication by connecting devices mounted on the vehicle 100. The wire harness routing structure 1 of the present embodiment is provided, for example, in a dash panel 120 of the vehicle 100. The dash panel 120 is a partition wall that partitions an engine room 130 and the vehicle interior (cabin) of the vehicle 100, and constitutes a structural member (frame member) of the vehicle 100.

Here, in the present embodiment, the dash panel 120 is configured to include, for example, a dash panel body 125 made of metal and a vehicle body panel 110 made of resin. Then, in the present embodiment, the dash panel body 125 is integrally molded with a peripheral panel 115 and the like of the engine room 130. As a result, rigidity and strength of the dash panel 120 can be enhanced, and eventually the vehicle body panel 110 can be formed of a resin molded article. That is, in the present embodiment, the vehicle body panel 110 is formed of a component separate from the dash panel body 125. The vehicle body panel 110 is installed in, for example, a recess 121 formed in the dash panel body 125, and constitutes a part of the dash panel 120 together with the dash panel body 125.

Note that, in the description below, among a first direction, a second direction, and a third direction intersecting one another, the first direction is referred to as a “vehicle front-rear direction X”, the second direction is referred to as a “vehicle width direction Y”, and the third direction is referred to as a “vehicle height direction Z”. Here, the vehicle front-rear direction X, the vehicle width direction Y, and the vehicle height direction Z are substantially orthogonal to one another. The vehicle front-rear direction X typically corresponds to the entire length direction of the vehicle 100, the stacking direction of the wire harness routing structure 1, and the like. The vehicle width direction Y typically corresponds to the entire width direction of the vehicle 100, the longitudinal direction (extending direction) of the wire harness routing structure 1, and the like. The vehicle height direction Z typically corresponds to the vehicle height direction of the vehicle 100, the lateral direction of the wire harness routing structure 1, and the like. Note that each direction used in the description below will be described as a direction in a state where the wire harness routing structure 1 is assembled to the vehicle 100 unless otherwise specified.

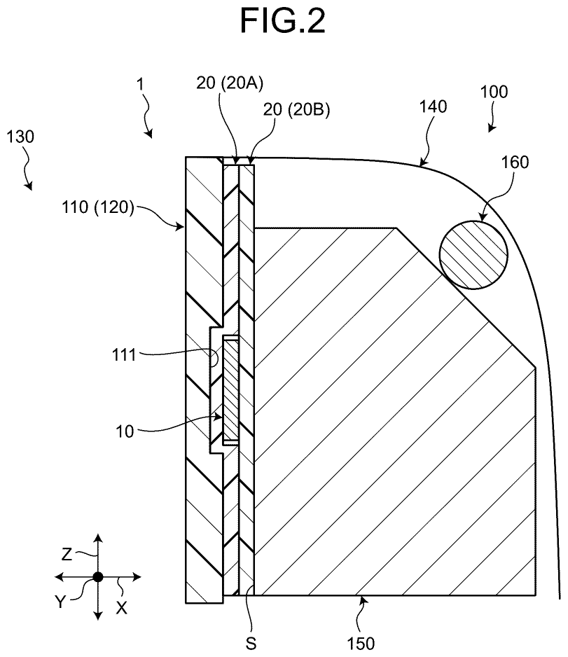

FIG. 2 is a cross-sectional view of the vehicle 100 to which the wire harness routing structure 1 is applied. As illustrated in FIG. 2, the wire harness routing structure 1 of the present embodiment is installed inside an instrument panel 140 of the vehicle 100, for example. The instrument panel 140 is an interior panel disposed on a front side of the vehicle interior along the vehicle width direction Y so as to face the driver seat and the passenger seat of the vehicle 100. An air conditioning unit 150, a reinforcement 160 as a reinforcing member extending along the vehicle width direction Y, and the like are provided inside the instrument panel 140. Flanges are joined to both ends of the reinforcement 160, one of the pair of flanges is fixed to the left side of the body of the vehicle 100, and the other is fixed to the right side of the body of the vehicle 100.

As illustrated in FIG. 2, the wire harness routing structure 1 of the present embodiment includes, for example, a flat routing member 10, a pair of elastic members 20, and a groove portion 111 formed in the above-described resin vehicle body panel 110 of the dash panel 120. The flat routing member 10 and the pair of elastic members 20 are disposed, for example, in a space S between the air conditioning unit 150 and the vehicle body panel 110 in the instrument panel 140.

The groove portion 111 is a recess formed in the vehicle body panel 110 described above, and extends along the vehicle width direction Y. The groove portion 111 is recessed from the inner surface of the vehicle body panel 110 toward the front side in the vehicle front-rear direction X and is opened toward the rear side in the vehicle front-rear direction X. The groove portion 111 has, for example, a shape along the outer diameter shape of the flat routing member 10, and functions as an alignment portion when the flat routing member 10 is attached. For example, the groove portion 111 integrally extends along the vehicle width direction Y so as to extend between a first ECU 40A (see FIG. 1) of a control device 40 provided at one end portion in the vehicle width direction Y and a second ECU 40E of the control device 40 provided at the other end portion in the vehicle width direction Y.

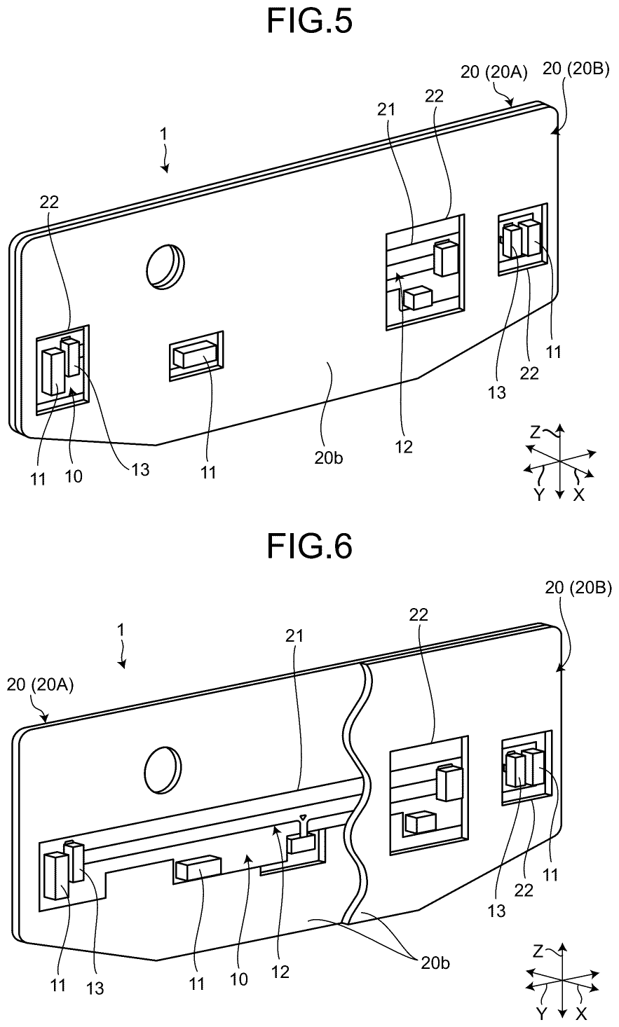

The flat routing member 10 is provided with connectors 11 (see FIGS. 5 and 6) at both end portions in the vehicle width direction Y. Then, the flat routing member 10 is connected to the first ECU 40A of the control device 40 via one connector 11, and is connected to the second ECU 40E of the control device 40 via the other connector 11. Note that the first ECU 40A and the second ECU 40E here are typically zone ECUs that integrally control devices in a peripheral region (zone) of the dash panel 120, but are not limited thereto. In addition, a plurality of devices 40B to 40D such as other ECUs of the control device 40 is provided between the first ECU 40A and the second ECU 40E, and the device 40C, which is one of them, is, for example, the above-described air conditioning unit 150 or the like. Note that, in FIG. 1, the pair of elastic members 20, the instrument panel 140, and the like are not illustrated for convenience.

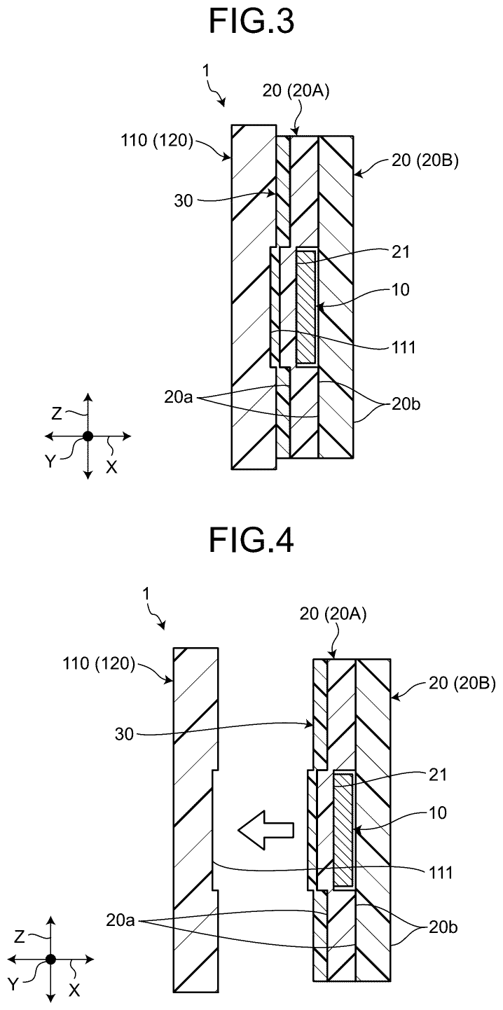

FIG. 3 is a cross-sectional view of the wire harness routing structure 1, and FIG. 4 is a cross-sectional view of the wire harness routing structure 1 and is a view of a state in which the flat routing member 10 and the pair of elastic members 20 are removed from the dash panel 120. As illustrated in FIGS. 3 and 4, for example, the pair of elastic members 20 holds the flat routing member 10 so as to sandwich the flat routing member 10 therebetween. The pair of elastic members 20 extends along the flat routing member 10 and is formed in a rectangular sheet shape (thin plate shape) that is horizontally long in the vehicle width direction Y. The length of the pair of elastic members 20 along the vehicle width direction Y is, for example, substantially the same as the length of the groove portion 111 and the flat routing member 10 along the vehicle width direction Y. The pair of elastic members 20 is stacked along the vehicle front-rear direction X.

The pair of elastic members 20 is configured to include, for example, a first sound absorbing material 20A on the vehicle body panel 110 side and a second sound absorbing material 20B on the air conditioning unit 150 side (vehicle interior side). The first sound absorbing material 20A and the second sound absorbing material 20B have a silencing function of suppressing a sound of the engine room 130 outside the vehicle body panel 110 from entering the vehicle interior. The first sound absorbing material 20A and the second sound absorbing material 20B are integrally bonded to each other by, for example, an adhesive such as hot melt, so that the flat routing member 10 disposed between the first sound absorbing material 20A and the second sound absorbing material 20B is held by the first sound absorbing material 20A and the second sound absorbing material 20B.

The first sound absorbing material 20A is formed in a substantially flat sheet shape, for example, similarly to the second sound absorbing material 20B. Therefore, in the first sound absorbing material 20A, in a state where the flat routing member 10 is sandwiched between the first sound absorbing material 20A and the second sound absorbing material 20B, a recess 21 recessed the thickness of the flat routing member 10 is formed. Note that the first sound absorbing material 20A is not limited to this example, and for example, the recess 21 for accommodating the flat routing member 10 may be formed in advance in a state where the flat routing member 10 is not sandwiched between the first sound absorbing material 20A and the second sound absorbing material 20B.

The first sound absorbing material 20A and the second sound absorbing material 20B are formed by, for example, forming a paper foam material obtained by foaming paper into a sheet shape. The paper foam material is obtained by mixing corn starch, polypropylene (PP), and the like with paper pellets and performing steam foaming. The first sound absorbing material 20A and the second sound absorbing material 20B, which are paper foam materials, have a labyrinth structure having semi-closed cells, and are excellent in sound energy absorbability by membrane vibration. In addition, the first sound absorbing material 20A and the second sound absorbing material 20B, which are paper foam materials, have low air permeability and excellent heat insulating properties.

Note that the second sound absorbing material 20B may be formed of a material different from that of the first sound absorbing material 20A, for example, polyvinyl chloride (PVC), polypropylene (PP), or the like having excellent weather resistance and strength in a sheet shape. The first sound absorbing material 20A and the second sound absorbing material 20B in a state of being bonded to each other are formed to be thicker than the dimension of the flat routing member 10 in a thickness direction (vehicle front-rear direction X). As described above, since the wire harness routing structure 1 of the present embodiment includes the first sound absorbing material 20A and the second sound absorbing material 20B having excellent sound absorbency, noise in the engine room 130 is suppressed from entering the vehicle interior. In addition, the first sound absorbing material 20A and the second sound absorbing material 20B also have excellent heat insulating properties.

That is, since the wire harness routing structure 1 of the present embodiment includes the first sound absorbing material 20A and the second sound absorbing material 20B obtained by forming a paper foam material having excellent sound absorbency and heat insulating properties in a sheet shape, it is possible to suppress the entry of noise and heat of the engine room 130 of the vehicle 100 with a minimum necessary amount without stacking a plurality of sound absorbing materials and heat insulating materials. That is, the flat routing member 10 constituting the wire harness can be assembled along a predetermined routing path while suppressing an increase in weight and bulkiness of manufacturing cost, and appropriate sound insulation performance and heat insulation performance can be secured.

In addition, the first sound absorbing material 20A and the second sound absorbing material 20B are fixed to the vehicle body panel 110 via an adhesive portion 30 with the flat routing member 10 interposed therebetween. The adhesive portion 30 is, for example, an adhesive, a double-sided tape, or the like, and is bonded to a back surface 20a of the first sound absorbing material 20A on the vehicle body panel 110 side. Note that a front surface 20b opposite to the back surface 20a of the first sound absorbing material 20A is bonded to the back surface 20a of the second sound absorbing material 20B via an adhesive. The widths of the first sound absorbing material 20A and the second sound absorbing material 20B along the vehicle height direction Z are set to be larger than the widths of the groove portion 111 and the flat routing member 10 along the vehicle height direction Z. That is, the first sound absorbing material 20A and the second sound absorbing material 20B are configured to include a portion overlapping a peripheral edge portion of the groove portion 111 in the vehicle body panel 110 in the vehicle front-rear direction X.

FIG. 5 is a perspective view of the wire harness routing structure 1, and FIG. 6 is a perspective view of the wire harness routing structure 1 and is a view of a state in which a part of the second sound absorbing material 20B of the pair of elastic members 20 is cut out. As illustrated in FIGS. 5 and 6, the flat routing member 10 is a routing member constituting the wire harness, and is configured by, for example, a flexible printed circuit (FPC), flexible flat cable (FFC), or the like. The flat routing member 10 is a thin and flexible flat routing member. The flat routing member 10 is formed in a rectangular plate shape horizontally elongated in the vehicle width direction Y as a whole. The flat routing member 10 is configured to include, for example, a base film, a wiring pattern, and a coverlay.

The base film is a base material that is excellent in flexibility and defines the entire shape of the flat routing member 10. The base film is formed of, for example, a polyimide resin or the like having excellent heat resistance. The wiring pattern is stacked on a surface (mounting surface) of the base film, for example, to constitute a plurality of conductor circuit portions (pattern layers). The wiring pattern is formed of a conductive material such as a copper foil, and is printed as a printed circuit body on the surface of the base film. The coverlay is stacked on the entire surface of the base film via an adhesive, which is not illustrated, and functions as a protective layer for protecting the conductor circuit portion and the like of the wiring pattern.

In addition, the plurality of conductor circuit portions configured by the wiring pattern can function as any circuit of, for example, a signal circuit, a signal GND circuit, a power ground circuit, and the like. The signal circuit is, for example, a circuit that transmits a communication signal between the control device 40 and in-vehicle devices such as various electronic devices in the vehicle 100. The signal GND circuit is a circuit that conducts between the in-vehicle devices in association with the signal circuit and adjusts a potential serving as a reference of a circuit operation between the in-vehicle devices. The power ground circuit is a circuit that grounds a power supply system of the in-vehicle devices.

The flat routing member 10 includes the connectors 11 at both end portions in the vehicle width direction Y. The pair of connectors 11 is exposed through through-holes 22 provided in the second sound absorbing material 20B. The through-holes 22 are openings penetrating the second sound absorbing material 20B along the vehicle front-rear direction X, and are configured as elongated holes larger than the outer shape of the connectors 11. The pair of connectors 11 is attached to the second sound absorbing material 20B in a state of penetrating the through-holes 22, and protrudes toward the rear side (the control device 40 side) in the vehicle front-rear direction X. Each of the pair of connectors 11 can be connected to a control device-side connector of the control device 40 described above.

For example, the connectors 11 are configured to be fittable to the control device-side connector depending on the fastening of the control device 40 to the vehicle body panel 110 by a fastening member. Specifically, in the present embodiment, a bolt of the fastening member protrudes from the vehicle body panel 110 toward the rear side (control device 40 side) in the vehicle front-rear direction X, and is fastened to a nut in a state of being inserted into a through-hole formed in the control device 40. As a result, the bolt of the fastening member functions as an assist bolt at the time of fitting between the connector 11 and the control device-side connector, and eventually, the fitting operation between the connector 11 and the control device-side connector can be performed more easily or more smoothly. For example, a pair of bolts of the fastening members is provided on both sides in the vehicle height direction Z so as to sandwich the connectors 11 and the control device-side connectors.

Note that, on the flat routing member 10, for example, a wiring module 12 configured by a bundle of high-speed communication lines, a bundle of power lines, or the like is stacked. The wiring module 12 includes connectors 13 at both end portions in the vehicle width direction Y. The pair of connectors 13 is exposed through the through-holes 22 provided in the second sound absorbing material 20B together with the pair of connectors 11 of the flat routing member 10. The pair of connectors 13 is attached to the second sound absorbing material 20B in a state of penetrating the through-holes 22, and protrudes toward the rear side (the control device 40 side) in the vehicle front-rear direction X. Each of the pair of connectors 13 can be connected to a control device-side connector of the control device 40 described above together with the pair of connectors 11 of the flat routing member 10.

As described above, the wire harness routing structure 1 of the present embodiment is configured to include the flat routing member 10. Therefore, the wire harness configured by the flat routing member 10 is reduced in weight as compared with a wire harness in which general various electrical wires are bundled. Here, in a case where the wire harness routing structure 1 described above is installed in the vehicle 100, the length of the wire harness is assumed to be about 1000 mm, and when all the wire harnesses having such a length are configured by electrical wires, the entire weight of the wire harnesses may increase. In this regard, according to the present embodiment, since the wire harness is configured to include the flat routing member 10, it is possible to support an increase in size of the wire harness while suppressing an increase in entire weight of the wire harness.

In addition, generally, a wire harness in which various electrical wires are bundled is manufactured manually by an operator. On the other hand, since the flat routing member 10 can be manufactured by automation, it is also possible to reduce the number of manufacturing steps of the wire harness by configuring the wire harness with the flat routing member 10. In addition, generally, a large wire harness in which various electrical wires are bundled has difficulty in transportation due to its weight. On the other hand, according to the present embodiment, the flat routing member 10 also has an advantage that, for example, the number of manufacturing days of the wire harness itself or the vehicle 100 using the wire harness is shortened, or the manufacturing place is hardly limited.

As described above, the wire harness routing structure 1 of the present embodiment includes the flat routing member 10 having flexibility and the pair of elastic members 20 extending along the flat routing member 10 and holding the flat routing member 10, and the flat routing member 10 is fixed to the dash panel 120 that partitions the engine room 130 and the vehicle interior of the vehicle 100 in a state of being sandwiched between the pair of elastic members 20. With this configuration, the wire harness routing structure 1 can assemble the flat routing member 10 constituting the wire harness to the vehicle 100 by, for example, sandwiching the flat routing member 10 between the pair of elastic members 20 and fixing them in an integrated state to the dash panel 120 of the vehicle 100. As a result, the wire harness routing structure 1 can improve the assemblability to the vehicle 100.

In addition, in the wire harness routing structure 1 of the present embodiment, the pair of elastic members 20 includes the first sound absorbing material 20A and the second sound absorbing material 20B that suppress a sound of the engine room 130 from entering the vehicle interior. With this configuration, in the wire harness routing structure 1, for example, a desired silencing effect can be obtained by the first sound absorbing material 20A and the second sound absorbing material 20B, and wear caused by interference between the first sound absorbing material 20A and the second sound absorbing material 20B and the flat routing member 10 can be suppressed.

In addition, in the wire harness routing structure 1 of the present embodiment, the flat routing member 10 is disposed in the space S between the air conditioning unit 150 and the dash panel 120 in the instrument panel 140 of the vehicle 100. With this configuration, the wire harness routing structure 1 can be disposed, for example, in the limited space S between the air conditioning unit 150 and the dash panel 120 in a state where the flat routing member 10 constituting the wire harness is sandwiched between the pair of elastic members 20 to further increase the protection and to further reduce the thickness.

In addition, the wire harness routing structure 1 of the present embodiment further includes the groove portion 111 formed in the dash panel 120 and having a shape along the outer shape of the flat routing member 10. With this configuration, in the wire harness routing structure 1, for example, the flat routing member 10 can be aligned with respect to the dash panel 120 by the groove portion 111, and eventually, the attachment operation of the flat routing member 10 and the pair of elastic members 20 to the dash panel 120 can be performed more easily, more smoothly, or more accurately. In addition, for example, when at least a part of the first sound absorbing material 20A on the dash panel 120 side of the pair of elastic members 20 is disposed in an embedded state in the groove portion 111, the entire wire harness including the flat routing member 10 and the pair of elastic members 20 may be further reduced in thickness.

In addition, in the wire harness routing structure 1 of the present embodiment, the dash panel 120 is configured to include the dash panel body 125 made of metal and provided with the recess 121 and the vehicle body panel 110 made of resin, installed in the recess 121, and constituting a part of the dash panel 120 together with the dash panel body 125, and the groove portion 111 is formed in the vehicle body panel 110. With this configuration, in the wire harness routing structure 1, for example, the groove portion 111 can be relatively easily formed because of the vehicle body panel 110 made of resin.

In addition, in the wire harness routing structure 1 of the present embodiment, the pair of elastic members 20 is fixed to the dash panel 120 via the adhesive portion 30 in a state of sandwiching the flat routing member 10. With this configuration, in the wire harness routing structure 1, for example, a fixing member such as a bolt for fixing the pair of elastic members 20 to the dash panel 120 can be eliminated (reduced) by the adhesive portion 30, and eventually the entire wire harness including the flat routing member 10, the pair of elastic members 20, and the adhesive portion 30 can be further reduced in thickness in some cases.

Note that, in the present embodiment, the case where the groove portion 111 is formed in the resin vehicle body panel 110 of the dash panel 120 has been exemplified, but it is not limited to this example, and for example, the groove portion 111 may be provided in the metal dash panel body 125 of the dash panel 120. In addition, in the present embodiment, the case where the pair of elastic members 20 includes the first sound absorbing material 20A and the second sound absorbing material 20B having a silencing function has been exemplified, but it is not limited to this example, and the pair of elastic members 20 may include, for example, elastic members 20 having no silencing function.

In addition, in the wire harness routing structure 1 of the present embodiment, for example, the vehicle body panel 110 itself having the groove portion 111 may constitute a part of the wire harness routing structure 1. That is, the wire harness routing structure 1 may be configured to include the vehicle body panel 110 made of resin (vehicle body panel 110 installed in recess 121 formed in dash panel body 125 made of metal) itself in addition to the flat routing member 10 and the pair of elastic members 20.

In a wire harness routing structure according to the present embodiment, a flat routing member constituting a wire harness can be assembled to a vehicle by sandwiching the flat routing member between a pair of elastic members and fixing them in an integrated state to a dash panel of the vehicle. As a result, the effect that the wire harness routing structure can improve the assemblability to the vehicle is provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness routing structure comprising:
a flat routing member that has flexibility; and
a pair of elastic members that extends along the flat routing member and holds the flat routing member, wherein
the flat routing member is fixed to a dash panel that partitions an engine room and a vehicle interior of a vehicle in a state of being sandwiched between the pair of elastic members.

2. The wire harness routing structure according to claim 1, wherein
the pair of elastic members includes sound absorbing materials that suppress a sound of the engine room from entering the vehicle interior.

3. The wire harness routing structure according to claim 1, wherein
the flat routing member is disposed in a space between an air conditioning unit and the dash panel in an instrument panel of the vehicle.

4. The wire harness routing structure according to claim 2, wherein
the flat routing member is disposed in a space between an air conditioning unit and the dash panel in an instrument panel of the vehicle.

5. The wire harness routing structure according to claim 1, further comprising:
a groove portion that is formed in the dash panel and has a shape along an outer shape of the flat routing member.

6. The wire harness routing structure according to claim 2, further comprising:
a groove portion that is formed in the dash panel and has a shape along an outer shape of the flat routing member.

7. The wire harness routing structure according to claim 5, wherein
the dash panel is configured to include a dash panel body made of metal and provided with a recess and a vehicle body panel made of resin, installed in the recess, and constituting a part of the dash panel together with the dash panel body, and
the groove portion is formed in the vehicle body panel.

8. The wire harness routing structure according to claim 6, wherein
the dash panel is configured to include a dash panel body made of metal and provided with a recess and a vehicle body panel made of resin, installed in the recess, and
constituting a part of the dash panel together with the dash panel body, and
the groove portion is formed in the vehicle body panel.

9. The wire harness routing structure according to claim 1, wherein
the pair of elastic members is fixed to the dash panel via an adhesive portion in a state of sandwiching the flat routing member.

10. The wire harness routing structure according to claim 2, wherein
the pair of elastic members is fixed to the dash panel via an adhesive portion in a state of sandwiching the flat routing member.
